(19) United States
(12) Patent Application Publication
(10) Pub. No.: US 2023/0245349 A1
(43) Pub. Date: Aug. 3, 2023

(54) DATA UPDATE METHOD, DATA UPDATE APPARATUS AND PROGRAM

(71) Applicant: NIPPON TELEGRAPH AND TELEPHONE CORPORATION, Tokyo (JP)

(72) Inventors: Mayuko WATANABE, Musashino-shi, Tokyo (JP); Ryuichi TANIDA, Musashino-shi, Tokyo (JP); Hideaki KIMATA, Musashino-shi, Tokyo (JP)

(73) Assignee: NIPPON TELEGRAPH AND TELEPHONE CORPORATION, Tokyo (JP)

(21) Appl. No.: 17/927,773

(22) PCT Filed: May 29, 2020
(86) PCT No.: PCT/JP2020/021364

§ 371 Date: Nov. 25, 2022

(51) Int. Cl. G06T 9/40

(52) U.S. Cl. CPC G06T 9/40

(57) ABSTRACT

A data update method for replacing at least part of encoded point cloud data in which presence or absence of a point is represented by a multi-tree structure for an individual divided region of a region indicated by point cloud data without decoding the multi-tree structure includes acquiring replacement destination data, acquiring replacement source data, which is the encoded point cloud data of the individual divided region corresponding to data to be replaced, and replacing the replacement source data with the replacement destination data.

### TECHNICAL FIELD

The present disclosure relates to a data update method, a data update apparatus, and a program.

### BACKGROUND ART

The existing three-dimensional measurement system uses a distance measurement system, such as light detection and ranging or laser imaging detection and ranging (LIDAR). The three-dimensional measurement system measures a position of an object, such as a structure (a building), by a laser scanner or the like, and acquires point cloud data which is a set of three-dimensional position data. The three-dimensional measurement system acquires the surface shape of the point cloud data. Estimating the surface shape of the object is then allowed in accordance with the three-dimensional point cloud data acquired by the three-dimensional measurement system.

Such a three-dimensional measurement system sometimes measures an identical region to be measured multiple times. This generates a plurality of pieces of point cloud data related to the identical region to be measured. For example, a plurality of measurement apparatuses each may measure the identical region to be measured or may measure the identical region to be measured from different directions multiple times. In such a case, the plurality of pieces of point cloud data may be merged (superimposed) for improvement in measurement accuracy. Further, for example, the identical region to be measured may be measured periodically at different timings. In such a case, the point cloud data of part of the region to be measured may be replaced or the like for updating the measurement result.

Merging (superimposition) of the plurality of pieces of point cloud data is said to be equivalent to replacement of part or all of a region indicated by one point cloud data with part or all of a region indicated by point cloud data merged with another point cloud data. The following description collectively refers to merge (superimposition) of a plurality of pieces of point cloud data and replacement of point cloud data of part of a region as “replacement.”

In addition, a known encoding technique encodes three-dimensional point cloud data by using a multi-level octree structure expressed by creating a cube including all points present in point cloud data and recursively dividing the created cube into eight cubes. An example of such an encoding technique is a point cloud compression (PCC), which is a method of compressing three-dimensional moving image data, and is being standardized in the Moving Picture Experts Group (MPEG) (see NPL 1). The PCC generates a reference encoded block in accordance with the minimum and maximum values of coordinates of point cloud data and represents the inside of the encoded block by an octree structure.

### CITATION LIST

### Non Patent Literature

NPL 1: Information technology - MPEG - I (Coded Representation of Immersive Media) - Part 9: Geometry-based Point Cloud Compression, ISO/IEC 23090-9: 2019 (E), ISO/IEC 2019
NPL 2: Paul J. Besl and Neil D. McKay, “A Method for Registration of 3-D Shapes,” IEEE Transactions on Pattern Analysis and Machine Intelligence, Vol. 14, No. 2, IEEE, pp. 239 - 256, February 1992

### SUMMARY OF THE INVENTION

### Technical Problem

When three-dimensional point cloud data is encoded by using such an octree structure, replacing a plurality encoded three-dimensional point cloud data with each other is difficult. This results from different reference encoded blocks for a plurality of pieces of different three-dimensional point cloud data, because the reference encoded blocks are generated in accordance with, for example, the minimum and maximum values of the coordinates of three-dimensional point cloud data.

In the related art, when point cloud data is encoded, replacing the encoded point cloud data with each other needs to once decode a plurality of pieces of encoded point cloud data. After the decoded point cloud data as coordinates data are replaced with each other, reencoding the replaced point cloud data is necessary. Therefore, replacing the encoded point cloud data with each other generates a calculation amount for decoding the encoded point cloud data and encoding the replaced point cloud data, causing an increased calculation amount as well as a complicated apparatus structure.

In response to the above circumstances, an object of the present disclosure is to provide a data update method, a data update apparatus, and a program capable of facilitating processing of replacing the encoded point cloud data with each other and reducing a calculation amount and a memory usage.

### Means for Solving the Problem

An aspect of the present disclosure is a data update method for replacing at least part of encoded point cloud data in which presence or absence of a point is represented by a multi-tree structure for an individual divided region of a region indicated by point cloud data without decoding the multi-tree structure. The method includes acquiring replacement destination data, acquiring replacement source data, which is the encoded point cloud data of the individual divided region corresponding to data to be replaced, and replacing the replacement source data with the replacement destination data.

An aspect of the present disclosure is a data update method for dividing a spatial region having point cloud data and representing a plurality of divided spatial regions by a multi-tree structure. The method includes acquiring point cloud data to be divided, and dividing the spatial region related to the point cloud data to represent, by a common multi-tree, a multi-tree structure representing at least part of a first divided spatial region of the plurality of divided spatial regions and a multi-tree structure representing at least part of a second divided spatial region of the plurality of divided spatial regions including the at least part of the first divided spatial region or included in the at least part of the first divided spatial region.

An aspect of the present disclosure is a data update apparatus for replacing at least part of encoded point cloud data in which presence or absence of a point is represented by a multi-tree structure for an individual divided region of a region indicated by point cloud data without decoding the multi-tree structure. The apparatus includes a first acquisition unit that acquires replacement destination data, a second acquisition unit that acquires replacement source data, which is the encoded point cloud data of the individual divided region corresponding to data to be replaced, and a replacement unit that replaces the replacement source data with the replacement destination data.

An aspect of the present disclosure is a program causing a computer to operate the data update method described above.

### Effects of the Invention

The present disclosure allows for facilitating processing of replacing encoded point cloud data with each other and reducing a calculation amount and a memory usage.

### BRIEF DESCRIPTION OF DRAWINGS

FIG. 1 is an overall configuration diagram of a three-dimensional position measurement system 1 according to a first embodiment of the present disclosure.

FIG. 2 is a schematic view illustrating a whole block defined by an information processing device 10 according to the first embodiment of the present disclosure.

FIG. 3 is a schematic view illustrating a dividing processing of a spatial region by the information processing device 10 according to the first embodiment of the present disclosure.

FIG. 4 is a schematic view illustrating a dividing processing of a spatial region by the information processing device 10 according to the first embodiment of the present disclosure.

FIG. 5 is a schematic view illustrating a dividing processing of a spatial region by the information processing device 10 according to the first embodiment of the present disclosure.

FIG. 6 is a schematic view illustrating an example of a positional relationship between two pieces of point cloud data to be merged.

FIG. 7 is a diagram illustrating an example of tree structure data converted from point cloud data A by an existing information processing device.

FIG. 8 is a diagram illustrating an example of tree structure data converted from point cloud data B by the existing information processing device.

FIG. 9 is a flowchart illustrating an encoding processing and a merging processing by the existing information processing device.

FIG. 10 is a schematic view illustrating a method of replacing point cloud data by the information processing device 10 according to the first embodiment of the present disclosure.

FIG. 11 is a schematic view illustrating a method of replacing point cloud data by the information processing device 10 according to the first embodiment of the present disclosure.

FIG. 12 is a schematic view illustrating a method of replacing point cloud data by the information processing device 10 according to the first embodiment of the present disclosure.

FIG. 13 is a flowchart illustrating an encoding processing and a merging processing by the information processing device 10 according to the first embodiment of the present disclosure.

FIG. 14 is a block diagram illustrating a functional configuration of the information processing device 10 according to the first embodiment of the present disclosure.

FIG. 15 is a flowchart illustrating an example of a merging processing by the existing information processing device.

FIG. 16 is a flowchart illustrating a merging processing by the information processing device 10 according to a modification example of the first embodiment of the present disclosure.

FIG. 17 is a flowchart illustrating a processing of defining a tree structure region by the existing information processing device.

FIG. 18 is a flowchart illustrating a processing of defining a tree structure region by the information processing device 10 according to the first embodiment.

FIG. 19 is a schematic view illustrating a method of defining a tree structure region by the information processing device 10 according to a second embodiment of the present disclosure.

FIG. 20 is a flowchart illustrating a processing of defining a tree structure region by the information processing device 10 according to the second embodiment.

FIG. 21 is a schematic view illustrating a method of defining a tree structure region by the information processing device 10 according to a third embodiment of the present disclosure.

FIG. 22 is a flowchart illustrating a processing of defining a tree structure region by the information processing device 10 according to the third embodiment.

FIG. 23 is a diagram illustrating an example of a positional relationship between two pieces of point cloud data to be replaced.

FIG. 24 is a schematic view illustrating a method of defining a tree structure region by the information processing device 10 according to a fourth embodiment of the present disclosure.

FIG. 25 is a flowchart illustrating a processing of defining a tree structure region by the information processing device 10 according to the fourth embodiment.

FIG. 26 is a schematic view illustrating a method of replacing point cloud data by the information processing device 10 according to a fifth embodiment of the present disclosure.

FIG. 27 is a schematic view illustrating a method of replacing point cloud data by the information processing device 10 according to the fifth embodiment of the present disclosure.

### DESCRIPTION OF EMBODIMENTS

Hereinafter, embodiments of the present disclosure will be described in detail with reference to the drawings.

The following description refers to “point cloud data” as data indicating a set of coordinates at which points are present in a predetermined spatial region. Point cloud data may also have an attribute, such as color information for each point. Further, “tree structure data” is referred to as data in which divided spaces including a measurement point in the spatial region is represented by an octree structure. Furthermore, “encoded data” is referred to as data obtained by encoding (for example, arithmetic encoding) the octree structure data. Although an embodiment describes the octree structure adopted by the above-described Pcc as an example, the present disclosure can be applied to any system in which presence or absence of a point in a spatial region is represented by a binary or higher order tree.

### First Embodiment

Hereinafter, the first embodiment according to the present disclosure will be described.

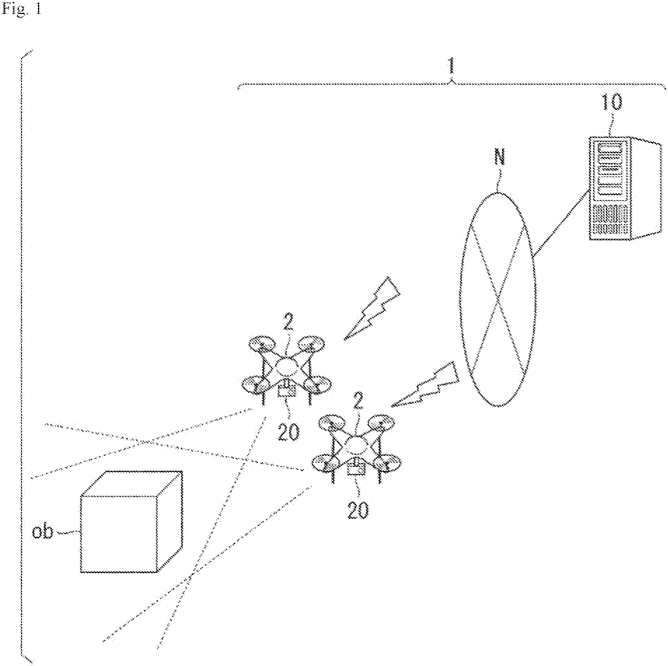

Configuration of Three-Dimensional Position Measurement System FIG. 1 is an overall configuration diagram of a three-dimensional position measurement system 1 according to the first embodiment of the present disclosure. As illustrated in FIG. 1, the three-dimensional measurement system 1 includes at least one movable body 2 (for example, two in FIG. 1) and an information processing device 10. The movable body 2 is, for example, an unmanned aerial vehicle (UAV), such as a drone, a manned aerial vehicle, a vehicle, a robot, a ship or the like. The present embodiment describes, as an example, the movable body 2 as an unmanned aerial vehicle. The information processing device 10 is, for example, a general-purpose computer such as a personal computer.

The movable body 2 is equipped with a point cloud data generation device 20. The point cloud data generation device 20 includes a distance measurement unit (not illustrated) and a position information acquisition unit (not illustrated). In the present embodiment, as an example, the description will be given on the assumption that the distance measurement unit is a laser scanner.

However, the distance measurement unit is not limited to a laser scanner. For example, a distance measurement device or the like that emits electromagnetic waves (light, radio waves) or ultrasonic waves having a directivity other than laser beam may be used as the distance measurement unit. Alternatively, for example, a handheld three-dimensional laser measurement device, a stereovision, a device capable of executing three-dimensional reconstruction of moving images recorded by a visible camera, or the like may be used as the distance measurement unit. Further, a device which is a combination of a laser scanner and a visible camera or the like may be used as the distance measurement unit.

The point cloud data generation device 20 irradiates a measurement object ob with a laser beam at a certain elevation angle and scans the measurment object ob with the laser beam in an irradiation azimuth angle direction. The measurement object ob is, for example, a structure such as a building and a house, or a device or the like provided in a measurement target region. The movable body 2 flies in a position where the point cloud data generation device 20 can irradiate the region to be measured including the measurement object ob with a laser beam and receive a reflected light thereof.

The scanning speed of the laser beam with respect to the region to be measured including the measurement object ob is typically sufficiently higher than the movement speed of the point cloud data generation device 20 (that is, the movement speed of the movable body 2 on which the point cloud data generation device 20 is mounted). Thus, a plurality of measurement points (intersection points) obtained by a single scan can be approximately considered to have been simultaneously irradiated with the laser beam.

The laser beam is reflected at a measurement point on the surface of the measurement object ob present in the region to be measured (that is, an intersection between the laser beam and the surface of the measurement object ob), and the reflected light is incident on the point cloud data generation device 20. The point cloud data generation device 20 measures the distance from the point cloud data generation device 20 to the measurement point based on the phase difference between the irradiated laser beam (irradiation light) and the reflected light. The point cloud data generation device 20 may be configured to calculate the distance from the point cloud data generation device 20 to the measurement point based on the time between irradiation of the laser beam and receipt of the reflected light. The point cloud data generation device 20 determines the relative position (relative coordinates) of the measurement point with respect to the point cloud data generation device 20 based on the measured distance and the azimuth angle in the irradiation direction of the laser beam.

Further, as described above, the point cloud data generation device 20 includes the position information acquisition unit (not illustrated). The position information acquisition unit is, for example, a global positioning system (GPS) receiver. The position information acquisition unit can acquire the position information indicating the position and posture of the point cloud data generation device 20 in the global coordinate system. The point cloud data generation device 20 can calculate the position (absolute coordinates) of the measurement point in the global coordinate system based on the position and posture of the point cloud data generation device 20 in the global coordinate system and the relative coordinates of the measurement point.

Note that the position information acquisition unit is not limited to a GPS receiver. The position information acquisition unit may be configured to include a device capable of directly measuring the present position of the point cloud data generation device 20, such as a laser distance meter, an ultrasonic distance meter, or a stereovision. Alternatively, the position information acquisition unit may be configured to include a simultaneous localization and mapping (SLAM).

The point cloud data generation device 20 generates three-dimensional point cloud data indicating a set of absolute coordinates of respective measurement points. The point cloud data generation device 20 generates three-dimensional point cloud data including about several tens of millions of measurement points by a single measurement, for example. The point cloud data generation device 20 is wirelessly connected to a communication network N, for example. The point cloud data generation device 20 transmits the generated three-dimensional point cloud data to the information processing device 10 via the communication network N.

The communication network N is, for example, the Internet, an exclusive line, or the like. The communication network N may be a wired network or may be a network which is a combination of wireless and wired networks.

The information processing device 10 acquires the three-dimensional point cloud data transmitted from the point cloud data generation device 20. The information processing device 10 converts the acquired three-dimensional point cloud data into tree structure data as described later. Further, the information processing device 10 encodes (arithmetically encodes, for example) the tree structure data into encoded data as described later. The information processing device 10 stores the encoded data.

Further, the point cloud data generation device 20 generates a plurality of pieces of three-dimensional point cloud data by irradiating a measurement target region including an identical measurement object ob with a laser beam a plurality of times. Therefore, each of the measurement target regions that are the measurement target for the plurality of pieces of three-dimensional point cloud data generated has a common spatial region. In other words, the common spatial region includes at least the measurement object ob and a spatial region adjacent to the measurement object ob.

For example, one point cloud data generation device 20 generates a plurality of pieces of three-dimensional point cloud data by irradiating an identical measurement target region with a laser beam from different directions while moving. However, the present disclosure is not limited to this configuration. For example, one point cloud data generation device 20 may generate a plurality of pieces of three-dimensional point cloud data by irradiating an identical measurement object ob with a laser beam at different timings (for example, at intervals of several hours or several days). Alternatively, a plurality of point cloud data generation devices 20 may irradiate an identical measurement target region with a laser beam (for example, at the same time), and each of the plurality of point cloud data generation devices 20 may generate three-dimensional point cloud data.

The information processing device 10 acquires each of the plurality of pieces of three-dimensional point cloud data generated for the measurement target regions having the common spatial region from the point cloud data generation device 20. The information processing device 10 converts each of the plurality of pieces of three-dimensional point cloud data into tree structure data and encodes each tree structure data into encoded data, as described later. The information processing device 10 stores each of a plurality of pieces of encoded data based on the plurality of pieces of three-dimensional point cloud data.

Subsequently, the information processing device 10 performs replacement using the plurality of pieces of encoded data generated for the measurement target regions having the common spatial region. As described above, the replacement includes a processing of merging (part or all of) the plurality of pieces of three-dimensional point cloud data based on the plurality of pieces of encoded data generated for the measurement target regions having the common spatial region, and a processing of replacing three-dimensional point cloud data of part of the region.

### Configuration of Information Processing Device

The configuration of the information processing device 10 will be described in more detail below.

The information processing device 10 acquires three-dimensional point cloud data from the point cloud data generation device 20. The information processing device 10 defines a spatial region of a cube (voxel) that includes the coordinates of all the measurement points indicated by the three-dimensional point cloud data. The spatial region to be defined may be a cuboid.

Hereinafter, the spatial region including the coordinates of all the measurement points indicated by the three-dimensional point cloud data is referred to as “a whole block.”

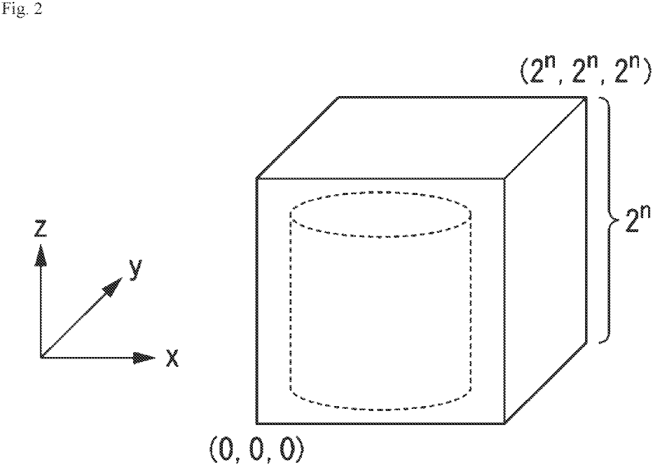

FIG. 2 is a schematic view illustrating the whole block defined by the information processing device 10 according to the first embodiment of the present disclosure. In FIG. 2, in order to simplify the view, the three-dimensional point cloud data (a set of coordinates of respective measurement points) is indicated in a cylindrical shape.

Each point of the three-dimensional point cloud data is data representing each measurement point having three coordinates (x, y, z). For example, each coordinate is expressed by a floating-point or fixed-point real number. Further, each point of the three-dimensional point cloud data may include additional information such as color information (RGB) and normal vector information, in addition to coordinate values of (x, y, z). To simplify the description, the present embodiment will represent the coordinate values (x, y, z) of each point of three-dimensional point cloud data as fixed-point values without including any additional information other than the coordinate values.

The information processing device 10 adjusts the minimum values of the coordinates (x, y, z) of a whole block to (0, 0, 0) by translating the coordinates (x, y, z) of each measurement point included in the three-dimensional point cloud data. Further, the information processing device 10 adjusts the maximum values of the coordinates (x, y, z) of the whole block such that, in the coordinates (x, y, z) of every measurement point included in the three-dimensional point cloud data, x < 2ⁿ, y < 2ⁿ, and z < 2ⁿ (here, n is a natural number) are true. That is, the maximum values of the coordinates (x, y, z) of the whole block are (2ⁿ, 2ⁿ, 2ⁿ). In addition, no measurement point is included on a plane of x = 2ⁿ, on a plane of y = 2ⁿ, and on a plane of z = 2ⁿ.

The information processing device 10 divides the whole block into eight cubic spatial regions (blocks) by dividing each side of the whole block into two.

Hereinafter, each of the divided spatial regions is referred to as “a partial block.”

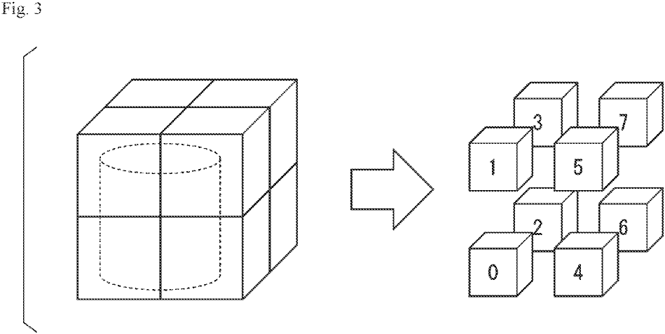

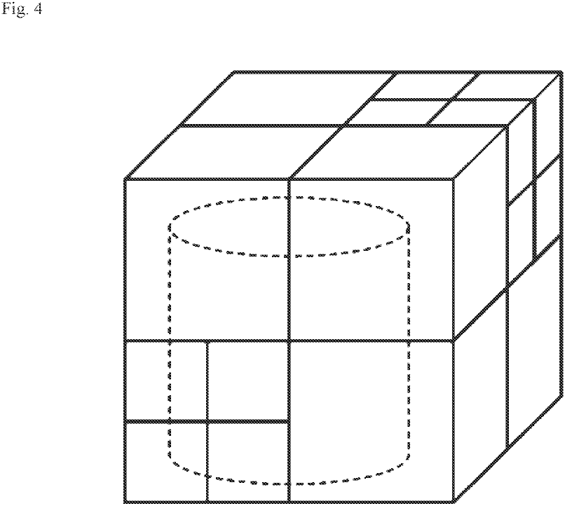

FIGS. 3 to 5 are schematic views illustrating a dividing processing of a spatial region by the information processing device 10 according to the first embodiment of the present disclosure. In FIGS. 3 and 4, in order to simplify the views, the three-dimensional point cloud data (a set of coordinates of respective measurement points) are indicated in a cylindrical shape.

As illustrated in FIG. 3, the information processing device 10 divides the whole block including all the three-dimensional point cloud data into eight partial blocks by dividing each side of the whole block into two. In FIG. 3, each of the eight partial blocks is labeled with “0” to “7.”

The information processing device 10 determines whether or not at least one point (that is, coordinate data of a measurement point) is included in each of the partial blocks labeled with “0” to “7.” The information processing device 10 further divides each of the partial blocks including at least one point into eight partial blocks. The information processing device 10 divides a partial block, which is a division target, into eight smaller partial blocks by dividing each side of the target partial block into two. The information processing device 10 does not divide a partial block with no point included.

FIG. 4 illustrates a dividing processing in the case where a point is included in at least the partial blocks labeled with “0” and “7” in FIG. 3. In addition, FIG. 4 illustrates a dividing processing in the case where no point is included in at least the partial blocks labeled with “1,” “3,” “4,” “5,” and “6” in FIG. 3.

The presence or absence of a point in each space included in the whole block divided into a plurality of partial blocks can be represented by tree structure data in an octree structure. The first level node of the octree structure represents the whole block. Each of the second or lower level nodes of the octree structure represents a partial block. For example, the nodes indicated with “0” and “7” in the second level correspond to the partial blocks labeled with “0” and “7” described above. Because the partial blocks labeled with “0” and “7” are further divided, each of the nodes indicated with “0” and “7” further branches into eight nodes in the third level.

Here, when a partial block including a point is represented by 1 and a partial block including no point is represented by 0, the value of each node of the octree structure can be represented by equation (1) below.

$$\begin{matrix}\text{f} \left({\text{α}}_{0} , {\text{α}}_{1} , {\text{α}}_{2} , {\text{α}}_{3} , {\text{α}}_{4} \text{,} {\text{α}}_{5} , {\text{α}}_{6} , {\text{α}}_{7}\right) \\ = \sum {\text{α}}_{\text{k}} {2}^{\text{k}} \left(\text{k = 0 to 7}\right)\end{matrix}$$

Here, αₙ represents a value (1 or 0) corresponding to the partial block labeled with a number “n” (n = 0 to 7) described above. For example, in the case of a node in which a point is included only in the partial blocks labeled with “0” and “1,” the value of the node is f(1, 1, 0, 0, 0, 0, 0, 0) = 3. Further, for example, in the case of a node in which a point is included in all the partial blocks labeled with “0” to “7,” the value of the node is f(1, 1, 1, 1, 1, 1, 1, 1) = 255. In this way, the value of each node can be represented by a value from 0 to 255. For example, for the dividing processing exemplified in FIGS. 3 to 5, the value of the fist level node corresponding to the whole block is f(1, 0, 0, 0, 0, 0, 0, 1) = 129.

The information processing device 10 encodes (for example, arithmetically encodes, or may encode the above-described translated data together) the tree structure data to obtain encoded data. The information processing device 10 stores the encoded data. As described above, the information processing device 10 stores each of the plurality of pieces of encoded data based on the plurality of pieces of three-dimensional point cloud data generated for the measurement target regions having the common spatial region. Subsequently, the information processing device 10 performs replacement using the plurality of pieces of encoded data.

In the following, the replacement by the information processing device 10 will be described.

As an example of the replacement, merging will be described below. That is, the following describes the case where a plurality of pieces of three-dimensional point cloud data generated for measurement target regions having a common spatial region are merged. Another replacement (for example, replacement of a plurality of pieces of three-dimensional point cloud data with each other) result in the same configuration described below.

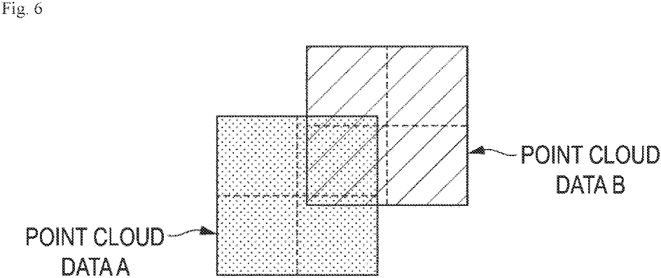

For ease of description, FIG. 6 and subsequent drawings represent a spatial region in two dimensions instead of three dimensions.

Further, for ease of description, a replacement method by the existing information processing device will be described first.

FIG. 6 is a schematic view illustrating an example of a positional relationship between two pieces of point cloud data to be merged. The two pieces of point cloud data to be merged are point cloud data A and point cloud data B. The point cloud data A and the point cloud data B are respectively sets of coordinate data of measurement points present in different measurement target regions having a common spatial region. As illustrated in FIG. 6, there is a region overlapping between the point cloud data A and the point cloud data B, and the overlapping region is the common spatial region described above.

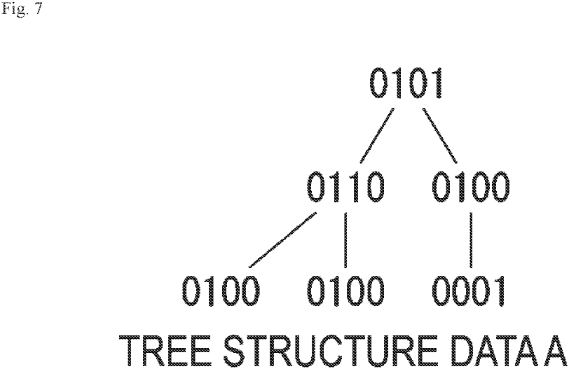

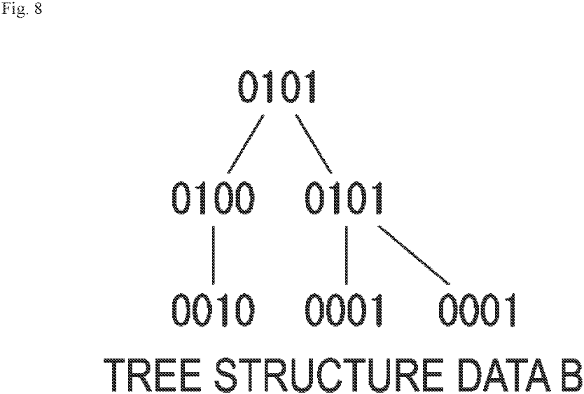

The existing information processing device decodes (for example, arithmetically decodes) a plurality of pieces of encoded data generated for a region to be measured having a common spatial region (for example, encoded data based on the point cloud data A and the point cloud data B illustrated in FIG. 6) to obtain corresponding tree structure data (for example, the tree structure data A illustrated in FIG. 7 and the tree structure data B illustrated in FIG. 8).

FIG. 7 is a diagram illustrating an example of tree structure data converted from the point cloud data A by the existing information processing device. FIG. 8 is a diagram illustrating an example of tree structure data converted from the point cloud data B by the existing information processing device.

As illustrated in FIG. 6, there is a deviation between the position of the whole block based on the point cloud data A and the position of the whole block based on the point cloud data B. Thus, there is also a similar deviation between the position of the partial block based on the point cloud data A and the position of the partial block based on the point cloud data B. This results from different positions of reference encoded blocks for different cloud group data, because the reference encoded blocks (whole block and partial block) are generated in accordance with the minimum and maximum values of the coordinates included in each of the point cloud data.

As described above, because the positions of the reference encoded blocks do not match each other, it is difficult to simply merge part of the tree structure data A converted from the point cloud data A illustrated in FIG. 7 and part of the tree structure data B converted from the point cloud data B illustrated in FIG. 8.

Thus, the existing information processing device converts the tree structure data A converted from the point cloud data A and the tree structure data B converted from the point cloud data B into corresponding point cloud data (that is, the point cloud data A and the point cloud data B which are coordinate data groups). The existing information processing device merges the point cloud data A and the point cloud data B which are the coordinate data groups. Then, the existing information processing device converts the merged point cloud data into tree structure data again and encodes the tree structure data to obtain merged encoded data.

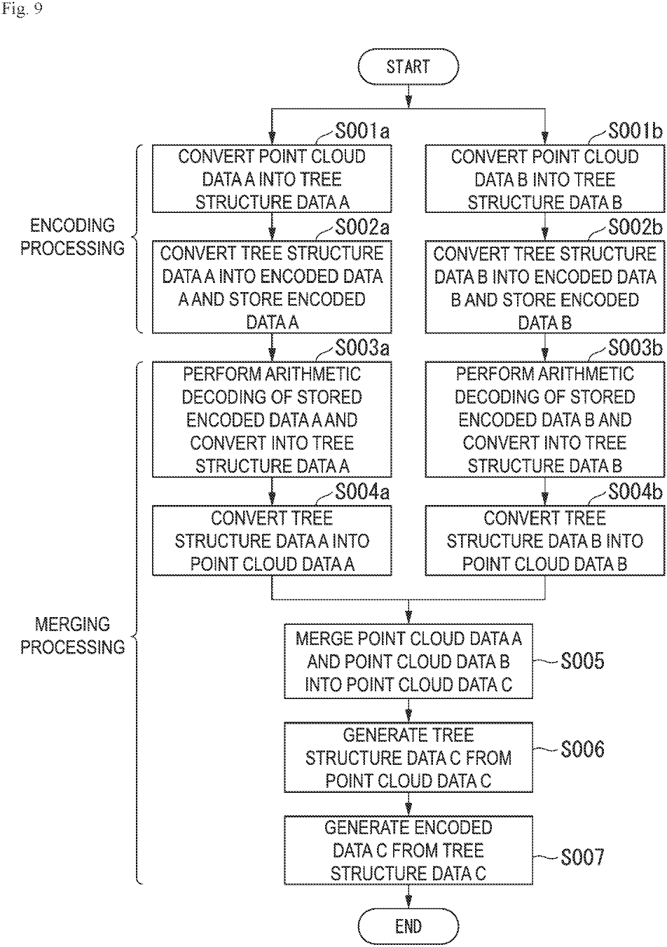

FIG. 9 is a flowchart illustrating an encoding processing and a merging processing by the existing information processing device. The flowchart starts when the existing information processing device acquires point cloud data (point cloud data A and point cloud data B) transmitted from a point cloud data generation device.

The existing information processing device converts point cloud data A into tree structure data A (step S001a). Then, the existing information processing device converts the tree structure data A into encoded data A and stores the encoded data A (step S002a). Meanwhile, the existing information processing device converts point cloud data B into tree structure data B (step S001b). Then, the existing information processing device converts the tree structure data B into encoded data B and stores the encoded data B (step S002b). The above is the encoding processing by the existing information processing device. Thereafter, the merging processing described below is performed at an arbitrary timing.

The existing information processing device performs arithmetic decoding of the stored encoded data A and converts it into tree structure data A (step S003a). Then, the existing information processing device converts the tree structure data A into point cloud data A (step S004a). Meanwhile, the existing information processing device performs arithmetic decoding of the stored encoded data B and converts it into tree structure data B (step S003b). Then, the existing information processing device converts the tree structure data B into point cloud data B (step S004b).

Next, the existing information processing device generates point cloud data C by merging the point cloud data A and the point cloud data B (step S005). Subsequently, the existing information processing device generates tree structure data C based on the point cloud data C (step S006). Then, the existing information processing device performs arithmetic encoding of the tree structure data C to generate encoded data C (step S007).

This is the end of the encoding processing and the merging processing by the existing information processing device shown in the flowchart in FIG. 9.

With the configuration described above, the existing information processing device can merge a plurality of pieces of encoded data generated for measurement target regions having a common spatial region. However, as described above, in order to perform replacement between a plurality of pieces of encoded point cloud data, the existing information processing device is required to decode the plurality of pieces of encoded data and restore them to corresponding point cloud data (coordinate data groups). For this reason, the calculation amount for encoding and decoding is increased and the device configuration is complicated.

In the following, a replacement method by the information processing device 10 according to the first embodiment will be described.

In the following description, two pieces of point cloud data to be merged are equivalent to the point cloud data A and the point cloud data B whose positional relationship is illustrated in FIG. 6, for example.

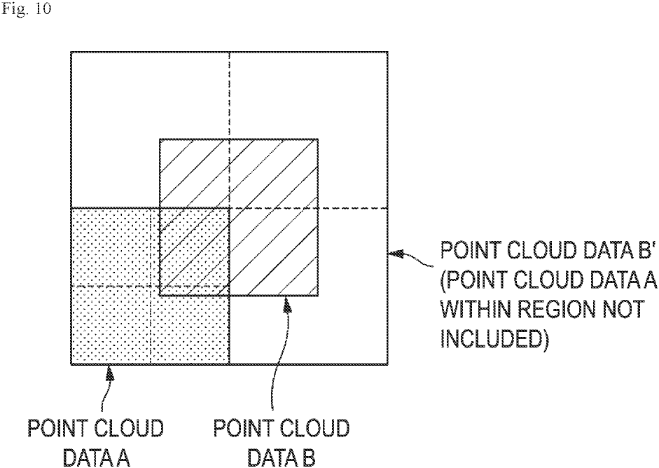

FIGS. 10 to 12 are schematic views illustrating a method of replacing point cloud data by the information processing device 10 according to the first embodiment of the present disclosure. As illustrated in FIG. 10, the information processing device 10 defines an encoded block which is an upper level encoded block having the spatial region of the whole block according to the point cloud data A as one partial block and including all the point cloud data of the point cloud data B (hereinafter, referred to as “B′ whole block as a spatial region for representing point cloud data B by a tree structure”). The B′ whole block as a spatial region for representing point cloud data B in a tree structure does not include respective points of the point cloud data A, but only includes respective points of the point cloud data B.

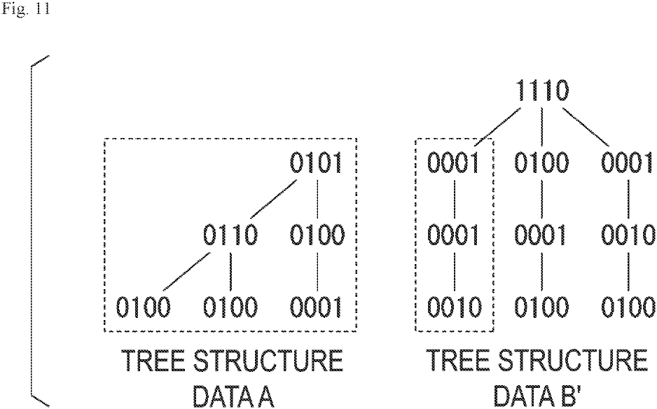

The information processing device 10 converts the point cloud data A into tree structure data A. Further, the information processing device 10 converts the B′ whole block as a spatial region for representing point cloud data B by a tree structure into tree structure data B′. FIG. 11 illustrates an example of the tree structure data A and the tree structure data B′ converted by the information processing device 10. The portions of the tree structure data A and the tree structure data B′ indicated with dotted lines in FIG. 11 correspond to the lower left partial block among four partial blocks obtained by dividing the B′ whole block as a spatial region for representing point cloud data B by a tree structure illustrated in FIG. 10 (that is, a spatial region corresponding to the whole block of the point cloud data A).

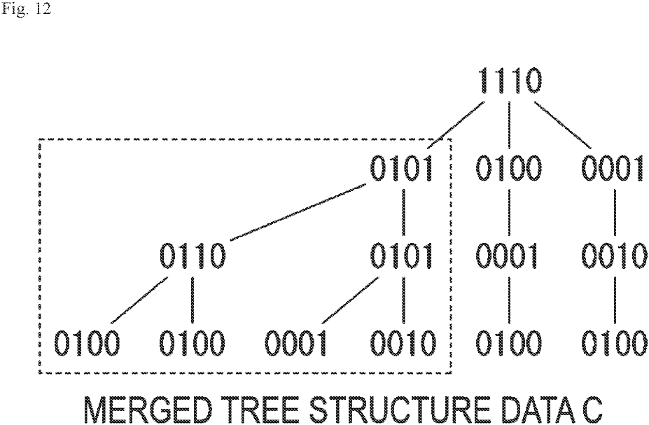

The information processing device 10 generates tree structure data C by merging the portion of the tree structure data A indicated with the dotted line in FIG. 11 and the portion of the tree structure data B′ indicated with the dotted line in FIG. 11. Specifically, the information processing device 10 calculates a logical sum for each level for both portions indicated with the dotted lines. FIG. 12 is a schematic view illustrating the tree structure data C generated by merging the tree structure data A and the tree structure data B′ illustrated in FIG. 11.

As described above, the information processing device 10 according to the present embodiment defines in advance a reference encoded block that is used in common by a plurality of pieces of point cloud data to be replaced so that a plurality of pieces of tree structure data can be added together.

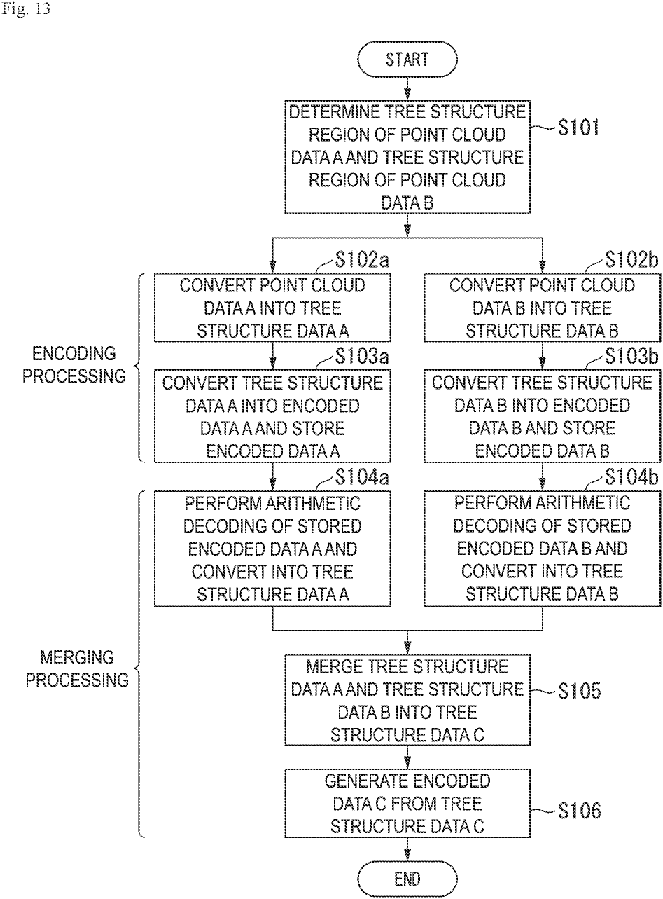

FIG. 13 is a flowchart illustrating an encoding processing and a merging processing by the information processing device 10 according to the first embodiment of the present disclosure. The flowchart starts when the information processing device 10 acquires point cloud data (point cloud data A and point cloud data B) transmitted from the point cloud data generation device 20. In the case where a common region between the point cloud data A and the point cloud data B is replaced with the content of the point cloud data B acquired later, the point cloud data B may be acquired first and the point cloud data (the point cloud data A) representing the spatial region corresponding to the point cloud data B may be acquired afterward. The same applies to embodiments other than the present embodiment.

The information processing device 10 determines tree structure regions of point cloud data A and point cloud data B (step S101). The tree structure regions of the point cloud data A and the point cloud data B are determined such that their reference encoded blocks match each other.

Next, the information processing device 10 converts the point cloud data A into tree structure data A (step S102a). Then, the information processing device 10 converts the tree structure data A into encoded data A and stores the encoded data A (step S103a). Meanwhile, the information processing device 10 converts the point cloud data B into tree structure data B (step S102b). Then, the information processing device 10 converts the tree structure data B into encoded data B and stores the encoded data B(step S103b). The above is the encoding processing by the information processing device 10 according to the first embodiment. Thereafter, the merging processing described below is performed at an arbitrary timing.

The information processing device 10 performs arithmetic decoding of the stored encoded data A and converts it into tree structure data A (step S104a). Meanwhile, the information processing device 10 performs arithmetic decoding of the stored encoded data B and converts it into tree structure data B (step S 104b). Next, the information processing device 10 generates tree structure data C by merging the tree structure data A and the tree structure data B (step S105). Then, the information processing device 10 generates encoded data C based on the tree structure data C (step S106).

This is the end of the encoding processing and the merging processing by the information processing device 10 according to the first embodiment shown in the flowchart in FIG. 13.

With the configuration described above, the information processing device 10 according to the first embodiment can merge a plurality of pieces of encoded data generated for measurement target regions having a common spatial region. Further, in the information processing device 10 according to the first embodiment, when replacement between a plurality of pieces of encoded point cloud data is performed, each of the plurality of pieces of encoded point cloud data is decoded into tree structure data, and replacement between the plurality of pieces of tree structure data is performed. That is, unlike the existing information processing device described above, the information processing device 10 according to the first embodiment is not required to decode the plurality of pieces of encoded point cloud data into a plurality of pieces of cloud data that are coordinate data groups.

This is because, for example, the information processing device 10 defines a common spatial region including both point cloud data A and point cloud data B (at a level higher than that of the whole block based on the point cloud data A) and generates tree structure data in an octree structure based on the common spatial region. This allows a plurality of pieces of tree structure data to be added together.

The replacement method by the information processing device 10 according to the present embodiment is effective, for example, when it is necessary to update (replace) point cloud data for an unexpected spatial region, in a situation where encoded data of point cloud data A already exist and at least part of the point cloud data A is replaced with at least part of point cloud data B, for example.

With the configuration described above, the information processing device 10 according to the first embodiment can facilitate the processing of replacement between a plurality of pieces of encoded point cloud data. Consequently, the increase in calculation amount and memory usage for encoding and decoding is suppressed, and the device configuration is simplified.

Hereinafter, a functional configuration of the information processing device 10 will be described.

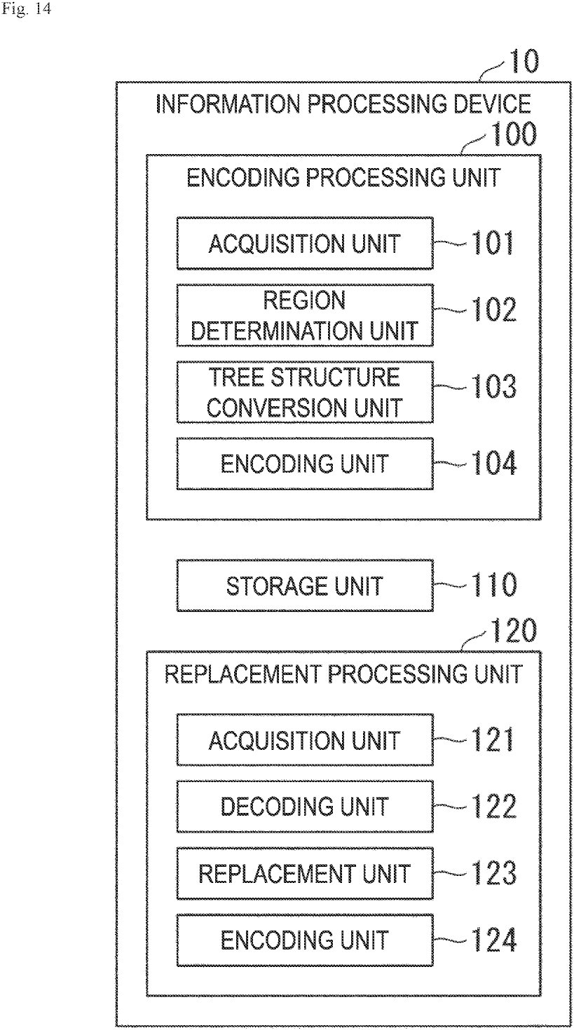

FIG. 14 is a block diagram illustrating a functional configuration of the information processing device 10 according to the first embodiment of the present disclosure. As illustrated in FIG. 14, the information processing device 10 includes an encoding processing unit 100, a storage unit 110, and a replacement processing unit 120.

The encoding processing unit 100 includes an acquisition unit 101, a region determination unit 102, a tree structure conversion unit 103, and an encoding unit 104.

The acquisition unit 101 acquires a plurality of pieces of three-dimensional point cloud data generated for measurement target regions having a common spatial region transmitted from the point cloud data generation device 20.

The region determination unit 102 determines a tree structure region of each of the plurality of pieces of three-dimensional point cloud data acquired by the acquisition unit 101. Respective tree structure regions are determined in a positional relationship such that their reference encoded blocks match each other.

The tree structure conversion unit 103 converts each of the plurality of pieces of three-dimensional point cloud data acquired by the acquisition unit 101 into tree structure data according to the tree structure region determined by the region determination unit 102.

The encoding unit 104 encodes (arithmetically encodes, for example) each of the plurality of pieces of tree structure data converted by the tree structure conversion unit 103. The encoding unit 104 records the plurality of pieces of encoded data in the storage unit 110.

The storage unit 110 stores each of the plurality of pieces of encoded data that are obtained by encoding the plurality of pieces of three-dimensional point cloud data generated for the measurement target regions having the common spatial region. Further, the storage unit 110 stores encoded data replaced by a replacement unit 123 to be described later. The storage unit 110 includes, for example, a storage medium such as a random access memory (RAM; readable/writable memory), a flash memory, an electrically erasable programmable read only memory (EEPROM), and a hard disk drive (HDD), or any combination of such storage media.

The replacement processing unit 120 includes an acquisition unit 121, a decoding unit 122, a replacement unit 123, and an encoding unit 124.

The acquisition unit 121 acquires each of the plurality of pieces of encoded data that are obtained by encoding the plurality of pieces of three-dimensional point cloud data generated for the measurement target regions having the common spatial region and are recorded in the storage unit 110 by the encoding unit 104.

The decoding unit 122 decodes (arithmetically decodes, for example) the plurality of pieces of encoded data acquired by the acquisition unit 121 and obtains tree structure data corresponding to each of the plurality of pieces of encoded data.

The replacement unit 123 replaces (for example, merges, replaces part of data, or the like) by using the plurality of pieces of tree structure data obtained by the decoding unit 122 to obtain replaced tree structure data.

The encoding unit 124 encodes (arithmetically encodes, for example) the replaced tree structure data obtained by the replacement unit 123. The encoding unit 104 records the replaced encoded data in the storage unit 110. Note that the encoding unit 124 and the above-described encoding unit 104 may be functional units composed of common hardware resources or software resources.

### Modification Example of First Embodiment

In the configuration of the information processing device 10 according to the first embodiment described above, after a plurality of pieces of three-dimensional point cloud data generated for measurement target regions having a common spatial region are acquired from the point cloud data generation device 20 and encoded, each encoded data is temporarily recorded in the storage unit 110. Subsequently, the information processing device 10 retrieves the plurality of pieces of encoded data from the storage unit 110 and perform replacement at an arbitrary timing. Such a configuration is suitable when timings of acquiring a plurality of pieces of three-dimensional point cloud data from the point cloud data generation device 20 are different from each other, for example when the three-dimensional point cloud data is partially updated at different timings (for example, regularly).

In contrast, when a plurality of pieces of three-dimensional point cloud data can be acquired at the same or nearly the same timing, a configuration is also conceivable in which replacement is performed immediately after the plurality of pieces of three-dimensional point cloud data are acquired without executing arithmetic encoding and arithmetic decoding. The following describes the case where a plurality of pieces of three-dimensional point cloud data obtained are immediately replaced.

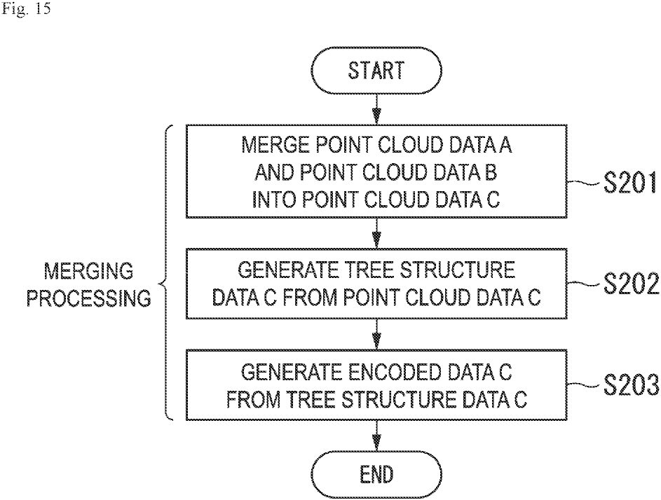

First, the case of the existing information processing device will be described. FIG. 15 is a flowchart illustrating an example of a merging processing by the existing information processing device. The flowchart starts when the existing information processing device acquires point cloud data (point cloud data A and point cloud data B) transmitted from a point cloud data generation device.

The existing information processing device generates point cloud data C by merging the point cloud data A and the point cloud data B (step S201). Subsequently, the existing information processing device generates tree structure data C based on the point cloud data C (step S202). Then, the existing information processing device encodes the tree structure data C to generate encoded data C (step S203).

This is the end of the merging processing by the existing information processing device shown in the flowchart in FIG. 15.

Next, the case of the information processing device 10 according to a modification example of the first embodiment will be described.

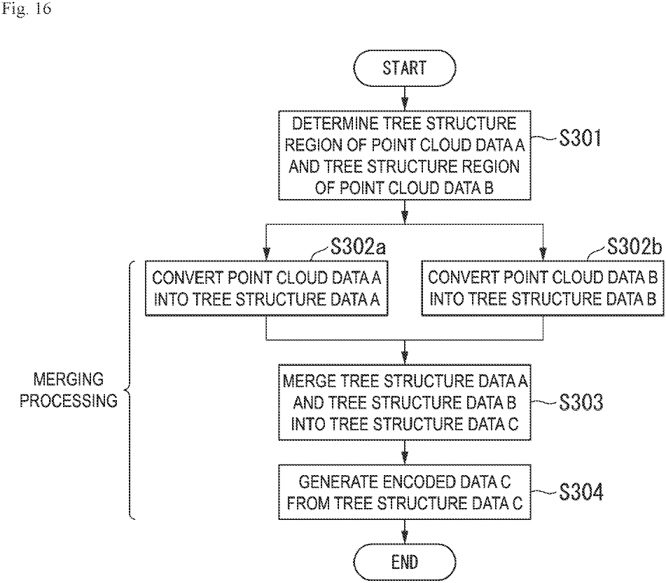

FIG. 16 is a flowchart illustrating a merging processing by the information processing device 10 according to a modification example of the first embodiment of the present disclosure. The flowchart starts when the information processing device 10 acquires point cloud data (point cloud data A and point cloud data B) transmitted from the point cloud data generation device 20.

The information processing device 10 determines tree structure regions of the point cloud data A and the point cloud data B (step S301). The tree structure regions of the point cloud data A and the point cloud data B are respectively determined such that their reference encoded blocks match each other. Next, the information processing device 10 converts the point cloud data A into tree structure data A (step S302a). Meanwhile, the information processing device 10 converts the point cloud data B into tree structure data B (step S302b). Next, the information processing device 10 generates tree structure data C by merging the tree structure data A and the tree structure data B (step S303). Then, the information processing device 10 encodes the tree structure data C to generate encoded data C (step S304).

This is the end of the merging processing by the information processing device 10 according to a modification example of the first embodiment shown in the flowchart in FIG. 16.

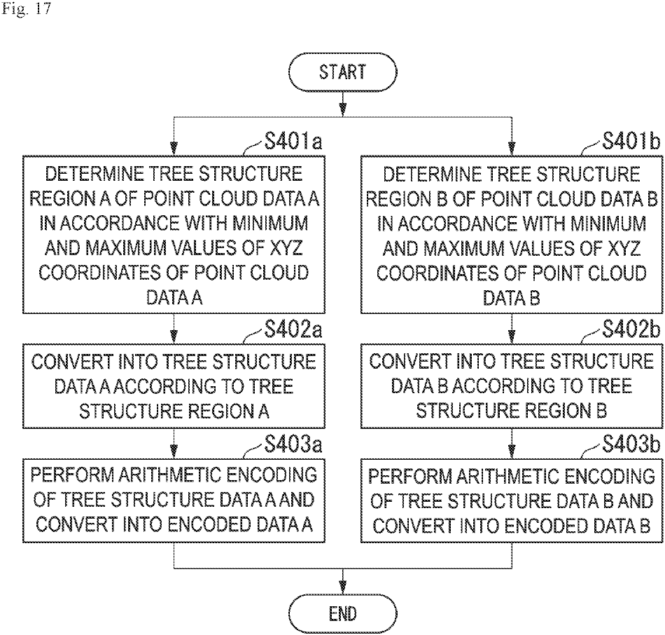

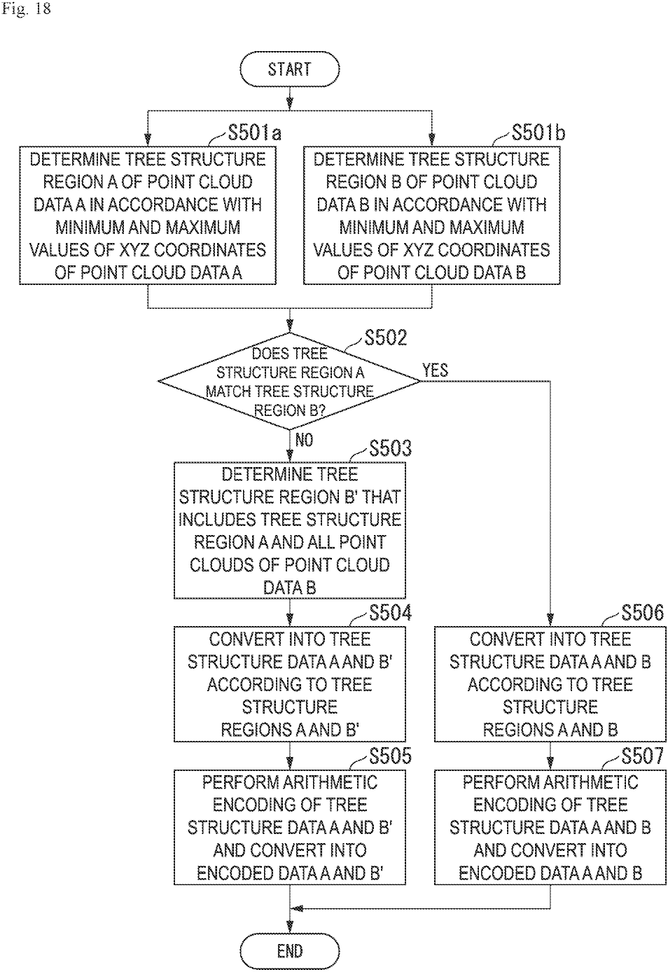

In the second to fourth embodiments described below, other variations of a method of determining a tree structure region of three-dimensional point cloud data will be described. In order to make it easier to understand the description of the method of determining a tree structure region of three-dimensional point cloud data according to the second to fourth embodiments, the method of determining a tree structure region of three-dimensional point cloud data by the existing information processing device and by the information processing device 10 according to the first embodiment will be described again first using the flowcharts in FIGS. 17 and 18.

FIG. 17 is a flowchart illustrating a processing of determining a tree structure region by the existing information processing device. The existing information processing device determines a tree structure region A of point cloud data A based on the minimum and maximum values of the (x, y, z) coordinates of the point cloud data A (step S401a). Next, the existing information processing device converts the point cloud data A into tree structure data A according to the tree structure region A (step S402a). Then, the existing information processing device performs arithmetic encoding of the tree structure data A and converts it into encoded data A (step S403a).

Meanwhile, the existing information processing device determines a tree structure region B of point cloud data B based on the minimum and maximum values of the (x, y, z) coordinates of the point cloud data B (step S401b). Next, the existing information processing device converts the point cloud data B into tree structure data B according to the tree structure region B (step S402b). Then, the existing information processing device performs arithmetic encoding of the tree structure data B and converts it into encoded data B (step S403b).

This is the end of the processing of determining a tree structure region by the existing information processing device shown in the flowchart in FIG. 17.

In this way, the existing information processing device defines an encoded block and a tree structure region for each of a plurality of pieces of point cloud data based on the minimum and maximum values of the (x, y, z) coordinates of each of the plurality of pieces of point cloud data. Therefore, replacement in a state of tree structure data is difficult because the positions of reference encoded blocks do not match in the processing of determining a tree structure region by the existing information processing device.

FIG. 18 is a flowchart illustrating a processing of determining a tree structure region by the information processing device 10 according to the first embodiment. The information processing device 10 determines a tree structure region A of point cloud data A based on the minimum and maximum values of the (x, y, z) coordinates of the point cloud data A (step S501a). Meanwhile, the information processing device 10 determines a tree structure region B of point cloud data B based on the minimum and maximum values of the (x, y, z) coordinates of the point cloud data B (step S501b).

Next, when the tree structure region A and the tree structure region B do not match each other (step S502; No), the information processing device 10 determines tree structure region B′ that includes the tree structure region A and all point clouds of the point cloud data B (step S503). Subsequently, the information processing device 10 converts the point cloud data A and the point cloud data B into tree structure data A and tree structure data B′ according to the tree structure region A and the tree structure region B′, respectively (step S504). Then, the information processing device 10 performs arithmetic encoding of the tree structure data A and the tree structure data B′ and converts them into encoded data A and encoded data B′, respectively (step S505).

On the other hand, when the tree structure region A and the tree structure region B match each other (step S502; Yes), the information processing device 10 converts the point cloud data A and the point cloud data B into tree structure data A and tree structure data B according to the tree structure region A and the tree structure region B (step S506). Then, the information processing device 10 performs arithmetic encoding of the tree structure data A and the tree structure data B and converts them into encoded data A and encoded data B (step S507).

This is the end of the processing of determining a tree structure region by the information processing device 10 according to the first embodiment shown in the flowchart in FIG. 18.

### Second Embodiment

In the following, a processing of determining a tree structure region by the information processing device 10 according to the second embodiment of the present disclosure will be described. Here again, as an example, the description will be given on the assumption that the positional relationship between a plurality of pieces of point cloud data to be merged is equivalent to that between two pieces of point cloud data (point cloud data A and point cloud data B) illustrated in FIG. 6.

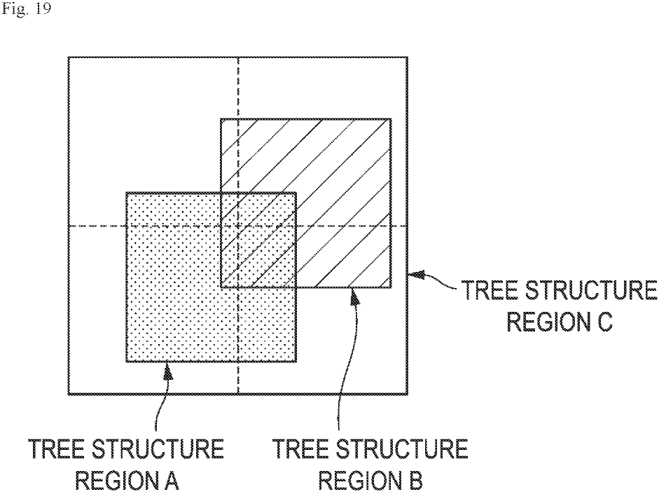

FIG. 19 is a schematic view illustrating a method of determining a tree structure region by the information processing device 10 according to the second embodiment of the present disclosure. As illustrated in FIG. 19, the information processing device 10 defines a tree structure region C that includes all measurement points included in point cloud data A and all measurement points included in point cloud data B.

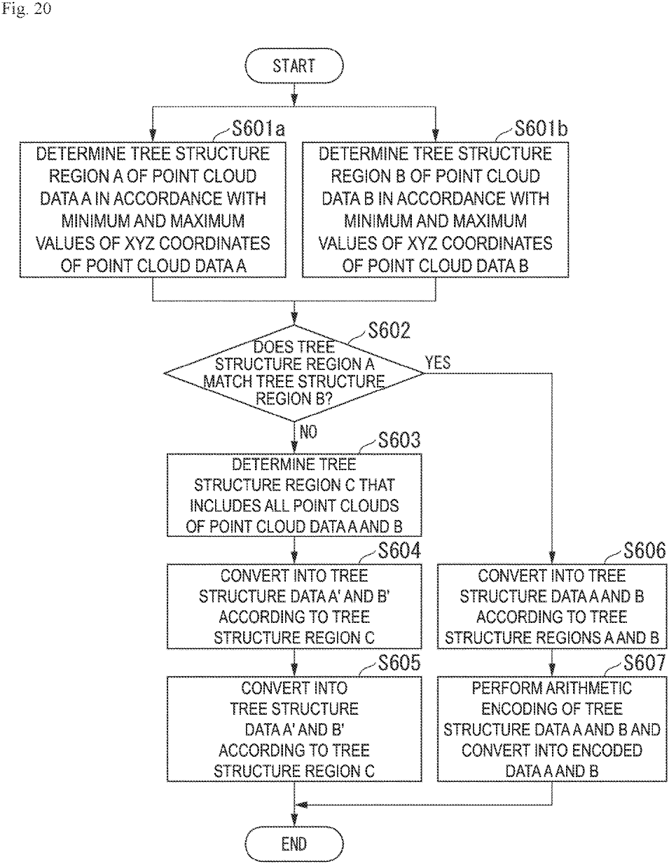

FIG. 20 is a flowchart illustrating a processing of determining a tree structure region by the information processing device 10 according to the second embodiment. The information processing device 10 determines a tree structure region A of the point cloud data A based on the minimum and maximum values of the (x, y, z) coordinates of the point cloud data A (step S601a). Meanwhile, the information processing device 10 determines a tree structure region B of the point cloud data B based on the minimum and maximum values of the (x, y, z) coordinates of the point cloud data B (step S601b).

Next, when the tree structure region A and the tree structure region B do not match each other (step S602; No), the information processing device 10 determines a tree structure region C that includes all point clouds of the point cloud data A and all point clouds of the point cloud data B (step S603). Subsequently, the information processing device 10 converts the point cloud data A and the point cloud data B into tree structure data A′ and tree structure data B′ according to the tree structure region C (step S604). Then, the information processing device 10 performs arithmetic encoding of the tree structure data A′ and the tree structure data B′ and converts them into encoded data A′ and encoded data B′, respectively (step S605).

On the other hand, when the tree structure region A and the tree structure region B match each other (step S602; Yes), the information processing device 10 converts the point cloud data A and the point cloud data B into tree structure data A and tree structure data B, respectively, according to the tree structure region A and the tree structure region B (step S606). Then, the information processing device 10 performs arithmetic encoding of the tree structure data A and the tree structure data B and converts them into encoded data A and encoded data B, respectively (step S607).

This is the end of the processing of determining a tree structure region by the information processing device 10 according to the second embodiment shown in the flowchart in FIG. 20.

As described above, the replacement method by the information processing device 10 according to the second embodiment divides a spatial region to include both of the point cloud data A and the point cloud data B with the point cloud data A and the point cloud data B not encoded, and represents the divided spatial regions by an octree structure. In the replacement method according to the second embodiment, replacement can be performed without performing a special processing (for example, a processing of encoded block alignment) as long as within divided spatial regions.

### Third Embodiment

In the following, a processing of determining a tree structure region by the information processing device 10 according to the third embodiment of the present disclosure will be described. Here again, as an example, the description will be given on the assumption that the positional relationship between a plurality of pieces of point cloud data to be merged is equivalent to that between two pieces of point cloud data (point cloud data A and point cloud data B) illustrated in FIG. 6.

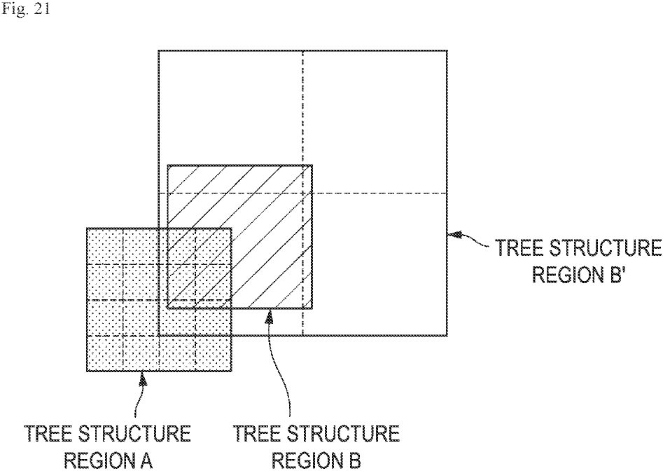

FIG. 21 is a schematic view illustrating a method of determining a tree structure region by the information processing device 10 according to the third embodiment of the present disclosure. As illustrated in FIG. 21, the information processing device 10 defines a tree structure region B′ having a vertex that is any one of the vertices of divided blocks (for example, partial blocks) of a tree structure region A, and including all measurement points included in point cloud data B.

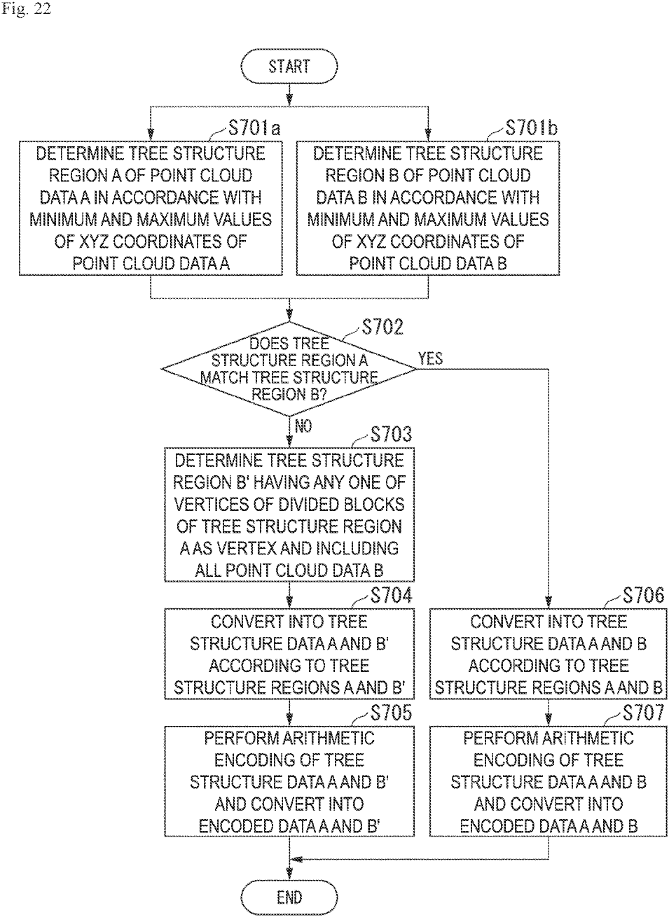

FIG. 22 is a flowchart illustrating a processing of determining a tree structure region by the information processing device 10 according to the third embodiment. The information processing device 10 determines a tree structure region A of point cloud data A based on the minimum and maximum values of the (x, y, z) coordinates of the point cloud data A (step S701a). Meanwhile, the information processing device 10 determines a tree structure region B of point cloud data B based on the minimum and maximum values of the (x, y, z) coordinates of the point cloud data B (step S701b).

Next, when the tree structure region A and the tree structure region B do not match each other (step S702; No), the information processing device 10 determines a tree structure region B′ having a vertex that is any one of the vertices of the divided blocks of the tree structure region A and including all the measurement points included in the point cloud data B (step S703). Subsequently, the information processing device 10 converts the point cloud data A and the point cloud data B into tree structure data A and tree structure data B′ according to the tree structure region A and the tree structure region B′, respectively (step S704). Then, the information processing device 10 performs arithmetic encoding of the tree structure data A and the tree structure data B′ and converts them into encoded data A and encoded data B′, respectively (step S705).

On the other hand, when the tree structure region A and the tree structure region B match each other (step S702; Yes), the information processing device 10 converts the point cloud data A and the point cloud data B into tree structure data A and tree structure data B, respectively, according to the tree structure region A and the tree structure region B (step S706). Then, the information processing device 10 performs arithmetic encoding of the tree structure data A and the tree structure data B and converts them into encoded data A and encoded data B, respectively (step S707).

This is the end of the processing of determining a tree structure region by the information processing device 10 according to the third embodiment shown in the flowchart in FIG. 22.

### Fourth Embodiment

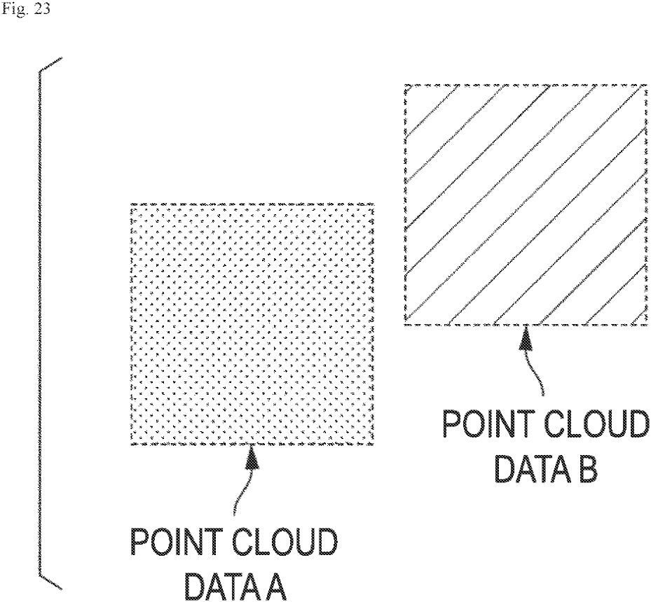

In the following, a processing of determining a tree structure region by the information processing device 10 according to the fourth embodiment of the present disclosure will be described. Here, as an example, the description will be given on the assumption that the positional relationship between a plurality of pieces of point cloud data to be merged is equivalent to that between two pieces of point cloud data (point cloud data A and point cloud data B) illustrated in FIG. 23. In the foregoing embodiments, the cases where partial regions represented by two pieces of point cloud data are overlapped with each other have been examined. In the present embodiment, a case where, although partial regions represented by two pieces of point cloud data are not overlapped, one block that is smaller by one or more units than a whole block can include both pieces of point cloud data will be examined. Taking the first defined cube as an example, one unit may refer to a size of one block obtained by dividing the cube into eight blocks, that is, a depth of level.

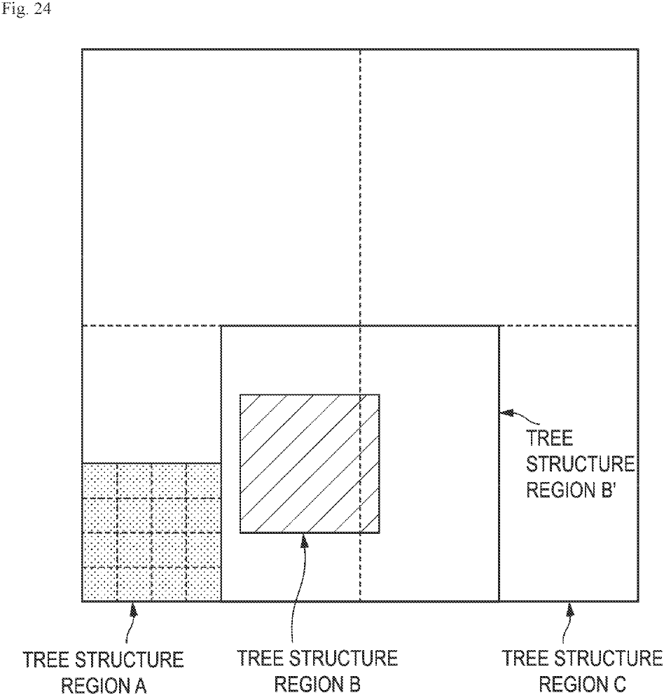

FIG. 24 is a schematic view illustrating a method of determining a tree structure region by the information processing device 10 according to the fourth embodiment of the present disclosure. As illustrated in FIG. 24, the information processing device 10 generates a tree structure region C that includes a tree structure region A and includes all measurement points included in point cloud data B. Then, the information processing device 10 defines a tree structure region B′ having a vertex that is any one of the vertices of the divided blocks (for example, partial blocks) of the tree structure region C, and including all the measurement points included in the point cloud data B.

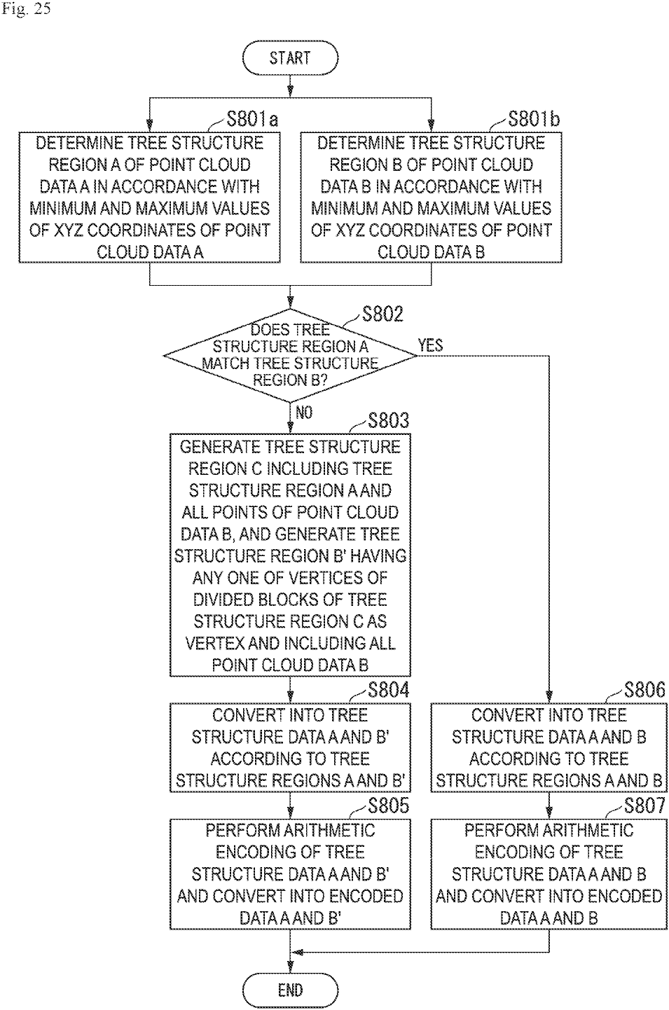

FIG. 25 is a flowchart illustrating a processing of determining a tree structure region by the information processing device 10 according to the fourth embodiment. The information processing device 10 determines a tree structure region A of point cloud data A based on the minimum and maximum values of the (x, y, z) coordinates of the point cloud data A (step S801a). Meanwhile, the information processing device 10 determines a tree structure region B of point cloud data B based on the minimum and maximum values of the (x, y, z) coordinates of the point cloud data B (step S801b).

Next, when the tree structure region A and the tree structure region B do not match each other (step S802; No), the information processing device 10 generates a tree structure region C that includes the tree structure region A and includes all the measurement points included in the point cloud data B. Then, the information processing device 10 generates a tree structure region B′ having a vertex that is any one of the vertices of the divided blocks of the tree structure region C and including all the measurement points included in the point cloud data B (step S803). Subsequently, the information processing device 10 converts the point cloud data A and the point cloud data B into tree structure data A and tree structure data B′ according to the tree structure region A and the tree structure region B′, respectively. (step S804). Then, the information processing device 10 performs arithmetic encoding of the tree structure data A and the tree structure data B′ and converts them into encoded data A and encoded data B′, respectively (step S805).

On the other hand, when the tree structure region A and the tree structure region B match each other (step S802; Yes), the information processing device 10 converts the point cloud data A and the point cloud data B into tree structure data A and tree structure data B, respectively, according to the tree structure region A and the tree structure region B (step S806).

Then, the information processing device 10 performs arithmetic encoding of the tree structure data A and the tree structure data B and converts them into encoded data A and encoded data B, respectively (step S807).

This is the end of the processing of determining a tree structure region by the information processing device 10 according to the fourth embodiment shown in the flowchart in FIG. 25.

### Fifth Embodiment

In the following, the fifth embodiment of the present disclosure will be described. In the foregoing embodiments, the cases where a so-called merging of point cloud data have been described. Here, another embodiment related to replacement of point cloud data will be described. The following description uses the example used in the first embodiment described above. However, the replacement processing described below may be performed in place of the merging processing according to another embodiment described above.

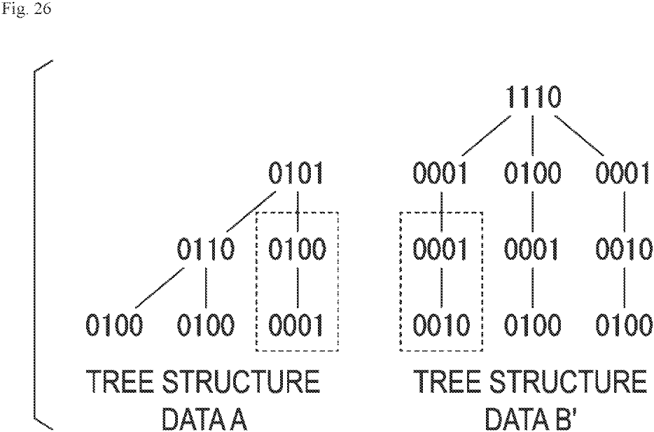

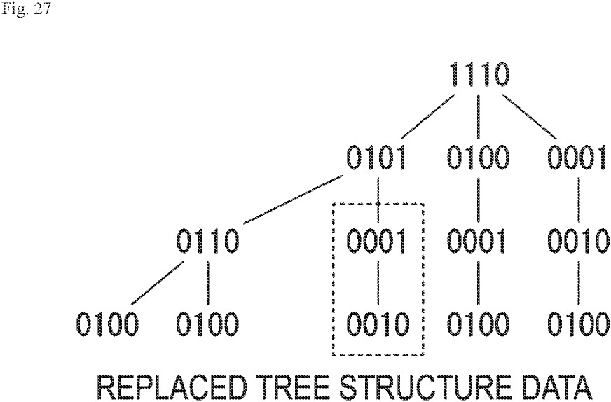

The description will be given using FIGS. 26 and 27. FIG. 26 illustrates two pieces of tree structure data A and B′ that represent two regions sharing a common portion. The tree structure data A and B′ are assumed to be encoded in determined blocks as described above. That is, a block determination method is equivalent to that in the first embodiment. The regions surrounded by dotted lines represent a common region. Here, note that the common region differs from that in the first embodiment. In addition, because the same example as that in the first embodiment is used, the block determination method is described as being equivalent to that in the first embodiment. However, a block determination method equivalent to that in another embodiment described above may be used.

FIG. 27 illustrates tree structure data after being replaced. Although merging is performed in the first embodiment, replacement with tree structure data B′ is performed in the present embodiment.

In addition, there may be an error in internal coordinates of point cloud data or a difference in accuracy between a plurality of pieces of point cloud data due to an error in coordinates acquired by GPS or a difference in positional relationship between a measurement object such as a building and a Lidar device at the time of acquiring point cloud data. In such a case, merging or replacement may be performed after the error or the difference in accuracy is corrected. Alternatively, it may be determined that merging or replacement is not performed depending on the magnitude of a difference in accuracy or an error. As a method of correcting an error or a difference in accuracy, for example, the method described in NPL 2 can be used.

According to each embodiment and a modification example thereof described above, a data update apparatus replaces at least part of encoded point cloud data that represents, by a multi-tree structure, the presence or absence of a point in each of divided regions obtained by dividing a region represented by point cloud data, without decoding the multi-tree structure. For example, the data update apparatus is an information processing device 10 according to an embodiment, the point cloud data is three-dimensional point cloud data according to an embodiment, the region represented by the point cloud data is a whole block according to an embodiment, the divided regions are partial blocks according to an embodiment, the point is a measurement point according to an embodiment, the multi-tree structure is an octree structure according to an embodiment, and the encoded point cloud data is tree structure data according to an embodiment.

The data update apparatus includes a first acquisition unit, a second acquisition unit, and a replacement unit. For example, the first acquisition unit and the second acquisition unit are an acquisition unit 121 according to an embodiment, and the replacement unit is a replacement unit 123 according to an embodiment.

The first acquisition unit acquires replacement destination data. For example, the replacement destination data is point cloud data A according to an embodiment. The second acquisition unit acquires replacement source data that is the encoded point cloud data of the divided regions corresponding to data to be replaced. For example, the replacement destination data is point cloud data B according to an embodiment. The replacement unit replaces the replacement source data with the replacement destination data.

The data update apparatus may further include a subdivision unit. For example, the subdivision unit is a region determination unit 102 according to an embodiment. The subdivision unit may divide a region that includes a first region corresponding to replacement destination data and a second region corresponding to replacement source data, and is larger than at least the second region, as the first region. For example, the first region is a spatial region where a spatial region based on a tree structure region A and a spatial region based on a tree structure region B according to an embodiment are overlapped with each other, the second region is a spatial region included in a tree structure region B according to an embodiment, and the region larger than the second region is a spatial region based on a tree structure region B′ according to an embodiment.

Further, the subdivision unit may divide a region that includes a first region including replacement destination data and a second region including replacement source data. For example, the first region is a spatial region based on a tree structure region A (in FIG. 3) according to an embodiment, and the second region is a spatial region based on a tree structure region B (in FIG. 3) according to an embodiment, and a region larger than the second region is a spatial region based on a tree structure region C (in FIG. 3) according to an embodiment.

Further, the subdivision unit may divide a third region that includes a first region corresponding to replacement destination data and a second region corresponding to replacement source data, and is larger than at least the second region, and has a vertex coincident with a vertex of the first region. For example, the first region is a spatial region based on a tree structure region A (in FIG. 4) according to an embodiment, the second region is a spatial region based on a tree structure region B (in FIG. 4) according to an embodiment, and the third region is a spatial region based on a tree structure region B′ (in FIG. 4) according to an embodiment.

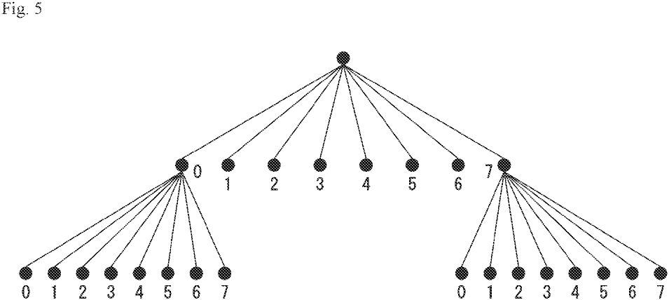

Further, the subdivision unit may define a third region that includes a first region corresponding to replacement destination data and a second region corresponding to replacement source data, and is larger than at least the second region, and divide a fourth region having a vertex that is any one of vertices of divided regions of the third region, and including the second region. For example, the first region is a spatial region based on a tree structure region A (in FIG. 5) according to an embodiment, the second region is a spatial region based on a tree structure B (in FIG. 5) according to an embodiment, the third region is a spatial region based on a tree structure region C (FIG. 5) according to an embodiment, and the fourth region is a spatial region based on a tree structure region B′ (in FIG. 5) according to an embodiment.

Further, according to each embodiment and a modification example thereof described above, the data update apparatus divides a spatial region including point cloud data and represents a plurality of divided spatial regions by a multi-tree structure. For example, the data update apparatus is an information processing device 10 according to an embodiment. The data update apparatus includes an acquisition unit and a division unit. For example, the acquisition unit is an acquisition unit 101 according to an embodiment, and the division unit is a region determination unit 102 according to an embodiment.

The acquisition unit acquires point cloud data to be divided. For example, the point cloud data to be divided is point cloud data A and point cloud data B according to an embodiment. The division unit divides a spatial region related to the point cloud data such that a multi-tree structure representing at least part of a first divided spatial region and a multi-tree structure representing at least part of a second divided spatial region including or included in at least part of the first divided spatial region are represented by a common multi-tree. For example, the first divided spatial region is a partial block based on point cloud data A or point cloud data B according to an embodiment, and the second divided spatial region is a partial block based on the point cloud data B or the point cloud data A according to an embodiment, the multi-tree structure is an octree structure according to an embodiment, and the common multi-tree is an octree according to an embodiment in the case where the positions of reference encoded blocks match each other.

With the configuration described above, an information processing device according to each embodiment and a modification example thereof can facilitate the processing of replacement between a plurality of pieces of encoded point cloud data.

Part or all of the information processing device 10 according to each embodiment described above may be implemented by a computer. In that case, the functions may be implemented by recording a program for implementing the functions in a computer readable recording medium and causing a computer system to read and execute the program recorded in the recording medium. Note that the “computer system” described here is assumed to include an OS and hardware such as a peripheral device. The “computer-readable recording medium” means a portable medium such as a flexible disk, a magneto-optical disk, a ROM, or a CD-ROM or a storage device such as a hard disk incorporated in the computer system. Moreover, the “computer-readable recording medium” may include a recording medium that dynamically holds the program for a short period of time, such as a communication line in a case in which the program is transmitted via a network such as the Internet or a communication line such as a telephone line, or a recording medium that holds the program for a specific period of time, such as a volatile memory inside a computer system that serves as a server or a client in that case.

Furthermore, the aforementioned program may be for implementing some of the aforementioned functions, or aforementioned functions may be implemented in combination with a program that has already been recorded in the computer system or by using a programmable logic device, such as a field programmable gate array (FPGA).

Although the embodiments of the present disclosure have been described in detail with reference to the drawings, a specific configuration is not limited to the embodiments, and a design or the like in a range that does not depart from the gist of the present disclosure is included.

### REFERENCE SIGNS LIST

1 Three-dimensional position measurement system
2 Movable body
10 Information processing device
20 Point cloud data generation device
100 Encoding processing unit
101 Acquisition unit
102 Region determination unit
103 Tree structure conversion unit
104 Encoding unit
110 Storage unit
120 Replacement processing unit
121 Acquisition unit
122 Decoding unit
123 Replacement unit
124 Encoding unit

1. A data update method for replacing at least part of encoded point cloud data in which presence or absence of a point is represented by a multi-tree structure for an individual divided region of a region represented by point cloud data without decoding the multi-tree structure, the data update method comprising:
acquiring replacement destination data;
acquiring replacement source data, which is the encoded point cloud data of the individual divided region corresponding to data to be replaced; and
replacing the replacement source data with the replacement destination data.

2. The data update method according to claim 1, further comprising
dividing, as a first region, a region that includes the first region corresponding to the replacement destination data and a second region corresponding to the replacement source data and is larger than at least the second region.

3. The data update method according to claim 1, further comprising
dividing a region including a first region containing the replacement destination data and a second region containing the replacement source data.

4. The data update method according to claim 1, further comprising
dividing a third region that includes a first region corresponding to the replacement destination data and a second region corresponding to the replacement source data, is larger than at least the second region, and has a vertex coincident with a vertex of the first region.

5. The data update method according to claim 1, further comprising
defining a third region that includes a first region corresponding to the replacement destination data and a second region corresponding to the replacement source data and is larger than at least the second region, and dividing a fourth region that has any one of vertices of a divided region of the third region as a vertex and includes the second region.

6. A data update method for dividing a spatial region having point cloud data and representing a plurality of divided spatial regions by a multi-tree structure, the data update method comprising:
acquiring point cloud data to be divided; and
dividing the spatial region related to the point cloud data to represent, by a common multi-tree, a multi-tree structure representing at least part of a first divided spatial region of the plurality of divided spatial regions and a multi-tree structure representing at least part of a second divided spatial region of the plurality of divided spatial regions including the at least part of the first divided spatial region or included in the at least part of the first divided spatial region.

7. A data update apparatus for replacing at least part of encoded point cloud data in which presence or absence of a point is represented by a multi-tree structure for an individual divided region indicated by point cloud data without decoding the multi-tree structure, the data update apparatus comprising:
a first acquisition unit configured to acquire replacement destination data;
a second acquisition unit configured to acquire replacement source data, which is the encoded point cloud data of the individual divided region corresponding to data to be replaced; and
a replacement unit configured to replace the replacement source data with the replacement destination data.

8. A non-transitory computer-readable medium having computer-executable instructions that, upon execution of the instructions by a processor of a computer, cause the computer to function as the data update method according to claim 1.
